(19) United States
(12) Patent Application Publication
(10) Pub. No.: US 2014/0139541 A1
(43) Pub. Date: May 22, 2014

(54) DISPLAY WITH OPTICAL MICROSCOPE EMULATION FUNCTIONALITY

(71) Applicant: Barco N.V., Kortrijk (BE)

(72) Inventors: Stephane Willaert, Edegem (BE); Lode De Paepe, Gent (BE); Matthew McLin, Hillsboro, OR (US); Tom Kimpe, Gent (BE); Cédric Marchessoux, Halluin (FR)

(21) Appl. No.: 14/057,033

(22) Filed: Oct. 18, 2013

Related U.S. Application Data
(60) Provisional application No. 61/715,350, filed on Oct. 18, 2012.

(51) Int. Cl. G06F 3/0362; G09G 5/10; G09G 5/02

(52) U.S. Cl. CPC G06F 3/0362; G09G 5/02; G09G 5/10
USPC 345/589; 345/581; 345/184

(57) ABSTRACT

An optical microscope digital image processing emulator or emulation is described in which a user input device is used to assist in the emulation of an operation of an optical microscope in a digital image processing system. The emulator or emulation is programmable via a library of processing functions stored in memory. The input device is adapted to generate control signals based on a user input, and to transfer the control signals to a processor, the processor being adapted to alter one or more parameters of the processing functions based on the control signals.

Embodiments of the present invention emulate the same control and responsiveness found with an optical microscope on a digital pathology computer system, thereby improving the workflow of pathology specialists by allowing better and faster control over the way images are presented.

### CROSS REFERENCE TO RELATED APPLICATIONS

This application claims priority from provisional patent application “A display with optical microscope emulation functionality”, application No. 61/715,350, filed Oct. 18, 2012, and incorporated herein by reference.

### BACKGROUND OF THE INVENTION

1. Field of the Invention

The present invention relates to an emulator or an emulation for a display, or a display with an emulator or emulation which enables the function of an optical microscope to be emulated or replicated when the display is in operation. The present invention also relates to a method of operating a display having display functions of an optical microscope, when the display is in operation. In particular the present invention relates to an Image Optimizer.

2. Description of Related Art

In many fields of activity having a scientific basis, optical microscopes are used to observe, record, and monitor especially in the biological and medical sciences. Optical microscopes are known, including their controls to e.g. change brightness appearance and application of specific colour filters.

It is also known to utilise computers and software for data acquisition. Such software can collect data from multiple channels, carry out an analysis and display the data. Data input into a computer can be first acquired and then processed or analysed, and finally the data is displayed.

Digital displays have been demonstrated that aim at mimicking optical microscope-like behaviour. However, existing “digital microscope” solutions are insufficient to mimic the behaviour of the optical microscopes accurately. In particular existing digital microscopes:

1) fail to accurately mimic the “brightness modulation” behaviour of optical microscopes, and/or
2) fail to accurately mimic the “colour filter” behaviour of optical microscopes, and/or
3) are drifting over time and differ from display to display due to the lack of calibration

Professionals looking at images, whether medical specialists doing digital diagnosis, or prepress specialists retouching photographs, or video post-processing specialists, need to be able to review images in the smallest details of the data spectrum. A default viewing state of a display system may offer an “best average” presentation that is satisfactory for most cases, but may actually hide precious details in the lighter or darker parts of the image (see FIG. 1).

As an example a feature to change the gamma may be present in conventional software (digital pathology viewer, or photoshop, or other types of software). These are often not compatible with any type of software, or any image displayed on the screen. Also the gamma change is often presented in a user unfriendly and non-intuitive way.

Doing real-time pixel processing on the full-screen desktop image is something that is currently not provided by standard graphics drivers.

### SUMMARY OF THE INVENTION

It is an object of the present invention to provide an emulator or an emulation for a display, or a display with an emulator or emulation which enables the function of an optical microscope to be emulated or replicated when a display of a digital imaging system is in operation. A further object of the present invention is to provide a method of preparing image data for a display or a method of operating a display having display functions of an optical microscope when the display of a digital imaging system is in operation. The display may be a fixed format display such as an LCD display having a backlight (or, for example, an OLED display, LED display, plasma display) which in accordance with embodiments of the present invention is enhanced with a microscope emulation or mimic function. Emulation involves hardware which executes code to enable real time microscope functions for the display. The task of an emulator is to reproduce by means of a combination of both hardware and software, some functions of an optical microscope for the display. The inputted data can be displayed in real time. A further object is to provide an Image Optimizer.

In embodiments of the present invention display methods and devices are provided for solving one or more of the following problems:

(1) a simple individual modulation of gamma, luminance or contrast results in e.g. loss of bit depth at low or high level greyscales and reduction of colour saturation;
(2) current and straightforward implementation of colour filters can result in a dangerous situation that colour behaviour will resemble the optical microscope behaviour for most of the image except for those areas where specific stains are being applied with spiked spectral behaviour. It is especially in these areas that pathologists will look for diagnostically relevant information. This means that the pathologists will have the impression that the filter works well (since most of the image behaves normally) but in fact the digital filter does not behave in the same way as the optical filter.

With respect to problem (1): in order to have a working solution, a simple combination of controlling the gamma and backlight luminance of an LCD display is insufficient. For example, embodiments of the present invention provide a specific relationship between display settings and gamma correction. Moreover, embodiments of the present invention have a further refinement of colour control when changing perceived brightness. This can also not be obtained by a mere combination of backlight luminance control with gamma control or something else.

With respect to problem (2) although a simple digital imaging filter does not work, embodiments of the present invention provide a more complex filtering.

According to an aspect of the present invention an optical microscope digital image processing emulator is provided, comprising:

a processor, a memory, a display, and a user input device, wherein
the emulator is programmable via a library of processing functions stored in the memory to emulate an operation of an optical microscope, the input device being adapted to generate control signals based on a user input, and to transfer the control signals to the processor, the processor being adapted to alter one or more parameters of the processing functions based on the control signals.

According to another aspect of the present invention an optical microscope digital image processing emulator for use with a display is provided, comprising:

a processor, a memory, and a user input device, wherein
the emulator is programmable via a library of processing functions stored in the memory to emulate an operation of an optical microscope, the input device being adapted to generate control signals based on a user input, and to transfer the control signals to the processor, the processor being adapted to alter one or more parameters of the processing functions based on the control signals.

This can be implemented as computer system including a processor wherein the control signals are first transferred to the computer system and then transferred to the display system. The computer system can be adapted to process or alter the control signals.

Alternatively, the processor is embedded in the display system.

The computer system can be an integral system or can be located remotely, e.g. on a data network such as on the internet or a local area network.

The input device can be a computer peripheral device or can be integrated into another component of the system such as in the display itself, e.g. as a touch screen.

The transfer of the control signals can take place by means of a wired or wireless communication channel or a combination of both. For example, the transfer of the control signals can take place by means of plug and play interface, or a USB, Bluetooth, Firewire or Ethernet protocol.

A software program running on the computer system can be provided for controlling the input device.

The user input device can have a knob which can be a physical knob or for example it can be the representation of a knob on a display screen, e.g. a touch screen. Also means allowing rotation of the knob clockwise or counter clockwise is provided with which the user interacts with the input device. The means for rotating a knob clockwise or counter clockwise can be part of a physical knob or can be a means for rotating an image of the knob on a display screen, e.g. a touch screen. The means for rotating a knob clockwise or counter clockwise can be adapted so that user interacts with the input device by controlling the rotation speed of the knob or the number of degrees the knob is being rotated. The user input device can include a further user action activator such as a button, either in the form of a physical button or of an icon on a display screen wherein the user interacts with the input device by pushing the button or activating the button, e.g. by means of a touch screen. For example, input device can be adapted so that the user interacts with the input device by controlling the duration of pushing or activating the button.

The user input device can be configured to mimic the controls of an optical microscope.

In embodiments the display can be adapted to transfer control signals to the input device. The input device can be adapted to alter its state or behaviour based on the control signals sent by the display to the input device. The input device can be adapted to alter its state or behaviour in order to provide feedback to the user.

The parameters of the processing functions that can be altered can be selected, for example, from one or more of backlight brightness, display brightness, display contrast, display colour point, colour settings, image processing filter settings, gamma value or calibration lookup table.

The emulator or emulation can be adapted so that two or more parameters of the processing functions are altered synchronously, for example display brightness and gamma value are altered synchronously, or the display brightness and display colour settings are altered synchronously, or the display brightness and display calibration lookup table are altered synchronously. Synchronously typically means within the same display frame or within the display frame blanking period.

In any of the embodiments the display can be adapted to display medical images, e.g. the display can be adapted to display digital pathology or whole slide imaging images

The parameters that are altered can be configured to mimic the behaviour of an optical microscope. The processing functions whose parameters are to be altered can be adapted to mimic the behaviour of an optical microscope. The behaviour of an optical microscopes can include at least one of changing brightness of the microscope light source, changing the light source spectrum of the microscope light source, adding optical filters to the microscope optical path, changing the zoom factor of the optical microscope, changing the position of the slide in the optical microscope.

The present invention also provides a method of operating an optical microscope digital image processing emulator, the optical microscope digital image processing emulator having a processor, a memory, a display, a user input device, wherein the emulator is programmable via a library of processing functions stored in the memory to emulate an operation of an optical microscope, the method comprising:
generating control signals based on a user input, and
transferring the control signals to the processor, the processor being adapted to alter one or more parameters of the processing functions based on the control signals.

A number of different programs for the processing functions are generated in the memory to create the library, e.g. by a compiler or other means. These programs are distributed to the processor to emulate the desired processing functions. Preferably, the compiler generated programs are stored in memory to allow these to instantly executing desired processing functions to achieve real-time effects. This can be achieved by generating a real time electric signal which can be used to operate, or trigger, other items of hardware such as the display.

The input/output to/from the emulator can be provided by a variety of sources such as from computer peripheral devices or via network communications interfaces (RS232, ETHERNET etc.) or bus interfaces such as IEEE-488-GPIB, ISA and EISA.

Embodiments of the present invention combine modification of a parameter of a processing function of a display, such as gamma control of a displayed image, with a simple and intuitive mechanical, e.g. rotary control. In addition an additional functionality such as a reset functionality is provided, e.g. by pressing the knob, can be provided.

A feature to change the gamma may be useful in a digital pathology viewer, or photoshop, or other types of software. Embodiments of the present invention can differentiate in one or both of two ways from conventional systems:

Firstly, changes in the parameter of a processing function such as a change in gamma correction can be provided at late on or at the last step in the visualization chain (i.e. in the graphic board or the display) and therefore are compatible with any software, or any image displayed on the screen. Secondly embodiments of the present invention can present the change in the parameter of a processing function, such as the gamma change, in a very user friendly and intuitive way (e.g. rotating a knob; pressing for resetting), thereby speeding up the process and eliminating a learning curve.

Embodiments of the present invention provide image professionals with better control over the image presentation, thereby allowing them to quickly and accurately change a parameter of a processing function such as viewing darker or lighter areas of the image. Having this control as implemented with embodiments of the present invention will help quality control, accuracy, speed of working or a combination of those elements.

For a pathologist, embodiments of the present invention allow immediate control over one or more functional features available on a traditional light microscope, but which may be hidden or not available in digital systems. The effects may include a faster and more intuitive workflow, and a more accurate diagnosis.

For a prepress specialist who retouches images, with embodiments of the present invention will allow faster inspection of dark and light areas of the image which would otherwise be invisible. The effects may include a faster workflow, and a more accurate work. A similar effect can be visible for specialists working with video (moving) images.

There are multiple ways to implement embodiments of the present invention such as:
1) Via a software tool that changes the video graphic board's look-up table and/or other processing functions.
2) Inside the display's hardware, by changing the look-up table inside the display electronics.

The present invention also provides a computer program product for implementing the emulator of the present invention when executed on a computer. The computer program product, can be stored on a non-transitory signal storage means which can be adapted for executing on a processing engine, the non-transitory signal storage means being such as an optical disk (CD-ROM, DVD-ROM) a magnetic disk, magnetic tape or a solid state memory such as a USB flash memory or in RAM, or similar.

### DESCRIPTION OF THE DRAWINGS

An embodiment of the present invention will now be described with reference to the drawings in which:

FIG. 1 shows a conventional image.

FIG. 2 shows a peripheral device in accordance with an embodiment of the present invention.

FIG. 3 illustrates how an embodiment of the present invention can alter the appearance of an image.

FIG. 4 shows an image processing system in accordance with an embodiment of the present invention.

FIG. 5 shows a further image processing system in accordance with an embodiment of the present invention.

FIG. 6 shows another image processing system in accordance with an embodiment of the present invention in which a driver is used to update a LUT.

FIG. 7 shows another image processing system in accordance with an embodiment of the present invention.

FIG. 8 shows a colour triangle.

FIG. 9 shows an image processing system in accordance with an embodiment of the present invention in which a 3D LUT is added to the Pixel shader.

FIG. 10 shows a histogram of an image and a histogram resulting from brightness adjustment.

FIG. 11 illustrates an image histogram when the gamma function is applied together with an increase in bit depth in accordance with an embodiment of the present invention.

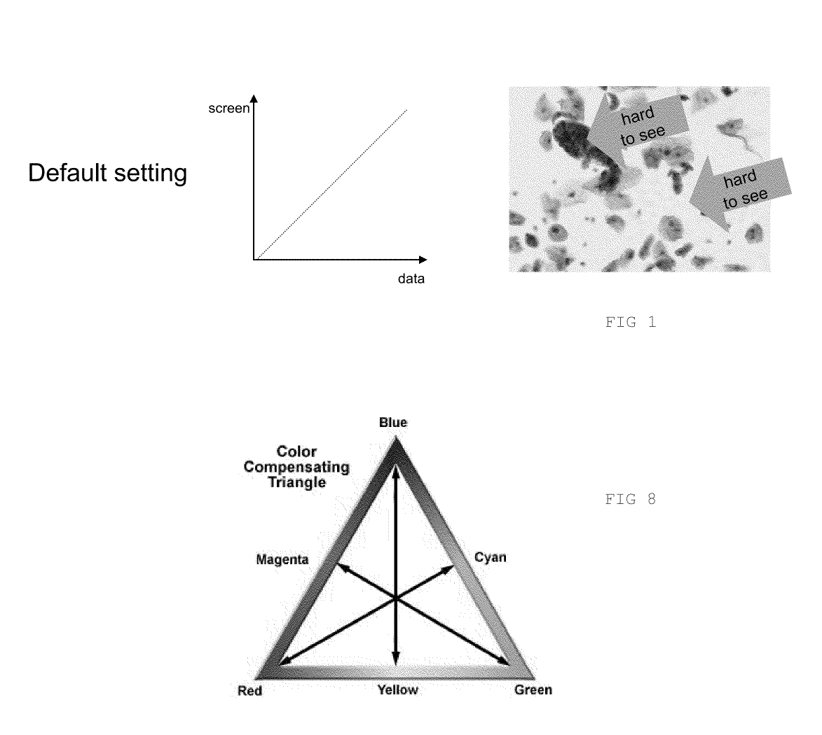

### DESCRIPTION OF THE PREFERRED EMBODIMENTS

The present invention is not limited to the described embodiments, but is limited only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Several embodiments of the present invention will be described below. All of these embodiments provide the same or a similar effect as far as the user experience is concerned. They may therefore be considered as parallel embodiments solving the same problem(s).

### EMBODIMENTS

Embodiments of the present invention provide an optical microscope digital image processing emulator or emulation in which a user input device is used to assist in the emulation of an operation of an optical microscope in a digital image processing system. The emulator or emulation is programmable via a library of processing functions stored in memory. The input device is adapted to generate control signals based on a user input, and to transfer the control signals to a processor, the processor being adapted to alter one or more parameters of the processing functions based on the control signals. The input device can be a physical device such as a computer peripheral or it can be displayed as an image, e.g. on a touch screen.

One such processing function parameter is gamma control, for example of an image to be displayed. Other parameters of the processing functions that are included in embodiments of the present invention include any of backlight brightness, display brightness, display contrast, display colour point, colour settings, image processing filter settings, or calibration lookup table. In accordance with embodiments of the present invention, the parameters and the functions can be configured to mimic the behaviour of an optical microscope. For example, the parameter(s) can be changing function that mimic brightness of the microscope light source, changing the light source spectrum of the microscope light source, adding optical filters to the microscope optical path, changing the zoom factor of the optical microscope, changing the position of the slide in the optical microscope.

### Embodiment 1

### User Input Device

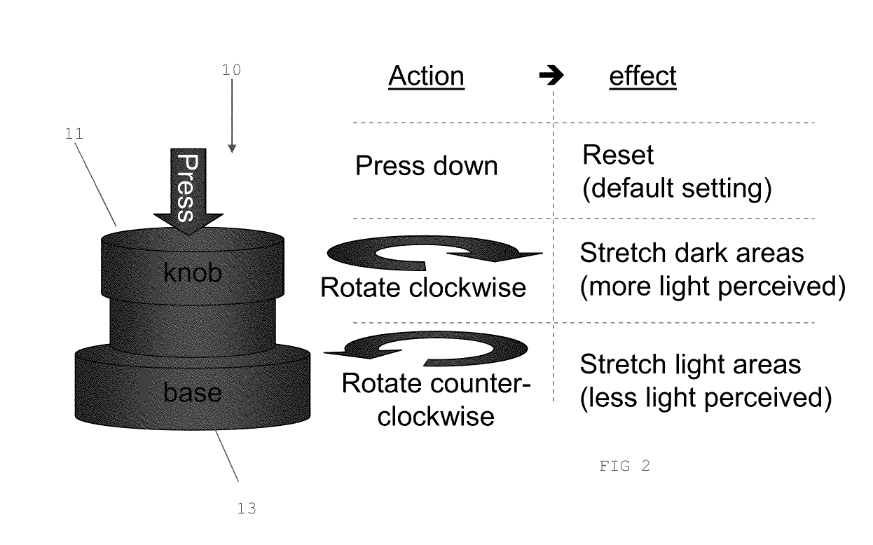

Any of the embodiments of the present invention can include or make use of a user input device which in one form is an electromechanical peripheral device as shown in FIG. 2. Any of the embodiments of the present invention can provide, as one option, the changing of a parameter for a processing function such as gamma control of the image with a simple and intuitive electromechanical user device of the type shown in FIG. 2. Such a device may have a rotary control knob, optionally with a further functionality by pressing the knob such as a reset functionality to a default setting (see FIG. 2).

The user device 10 shown in FIG. 2 is a computer peripheral device 11, 13, 15 which is an electromechanical device, having a rotating knob 11 which rotates with respect to a base 13. Rotation alters the data and/or commands available from the device 10, e.g. positional information may be made available by the device 10, this positional information being for use by a processing device to alter a processing function for an image, e.g. as an input variable. The base 13 is provided with a communications interface 15 (not shown) for communicating such information to electronic devices such as a processing device like a computer, tablet, PDA, laptop, workstation, smartphone or with a display device, the processing device having, for example, a fixed format display of which LCD, LED, OLED and plasma displays are examples. The interface 15 may include network interface and can include a processor such as a microprocessor or an FPGA and memory.

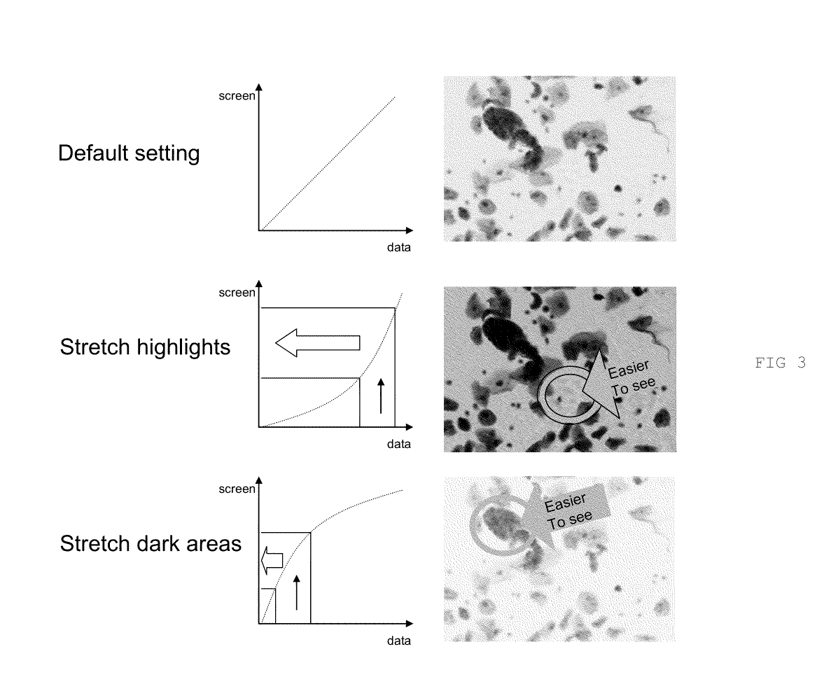

Purely as an example of the processing function that can be amended, in embodiments of the present invention, altering the user input device 10, e.g. by rotating the knob 11 can “stretch” or intensify the dark areas (e.g. clockwise rotation) (e.g.) compared to other areas, or “stretch” or intensify light areas (e.g. counter clockwise rotation) of the image (e.g. compared to other areas)—see FIG. 3—as displayed on a display screen. The perceived effect for the user is one of respectively higher brightness and/or lower brightness in parts of the image. Thus altering the user input device 10, e.g. rotating the knob 11 can alter absolute or relative intensities of certain or different parts of the image. This results in improved detail in respectively dark parts of the image and/or light parts of the image. In some embodiments the overall brightness of the display can be altered, e.g. by altering the backlight intensity of a display.

The user makes use of means for rotating a knob clockwise or counter clockwise to provide user interaction with the user input device, e.g. by controlling the rotation speed of the knob or the number of degrees the knob has being rotated. The user may interact with the user device 10 in other ways to provide other functions. For example the user can interact with the input device 10 by pushing a button on this device or by pushing the knob. Additionally other functions may be provided when the user interacts with the input device by controlling the duration of pushing the button or knob.

Although in the above description actual rotation of the knob 11 is described the present invention also includes that movement of a hand or finger in a linear or rotating manner over the top of the device 10 results in the same effect. This can be obtained by the same methods as for a “swipe” on “touch screens”. For example the top of the device 10 can be a touch screen, and power for the screen can come through an interface such as a USB interface which is used to connect the device 10 to a display or a processing device. The ‘swipe’ starts by storing the location of the touch event on the screen at the initial X and initial Y co-ordinates. Then, after movement of the finger, the screen is released, and the difference between the initial and final touch coordinates is calculated and stored as delta X and delta Y variables from which the linear distance moved or the rotational angle moved can be calculated. Furthermore, the touch screen mentioned above could also be integrated in the display device itself, either as a touch sensitive area outside of the active display area, or as a touch sensitive area inside the active display area. This touch sensitive area inside the active display area could cover the entire active display area or only part of this active display area. Hence the user input device 10 can be implemented on a display screen or on the display screen of the imaging display system.

Hence, the user input device 10 may be coupled to a display device or be part of the display device. The display device can be adapted to display medical images, for example digital pathology or whole slide imaging images. The display device can be adapted to transfer control signals to the user input device. For example, the input device can be adapted to alter its state or behaviour based on the control signals sent by the display device to the input device. The input device 10 can be adapted to alter its state or behaviour in order to provide feedback to the user. The user input device 10 can be configured to mimic the controls of an optical microscope.

Preferably, the slightest alteration of the user input device 10, e.g. movement of the knob 11 has an immediate (real time) effect on the image, so as to allow an intuitive control of images. In pathological investigations for example, a useful effect is obtained on a microscope, by changing the brightness of the backlight. Embodiments of the present invention emulate the same control and responsiveness found with an optical microscope on a digital pathology computer system, thereby improving the workflow of pathology specialists by allowing better and faster control over the way images are presented.

Embodiments of the present invention may also provide similar in prepress, or video processing or other applications such as imaging or printing applications.

### Embodiment 2

### Emulation Executed in a GPU Pixel Shader

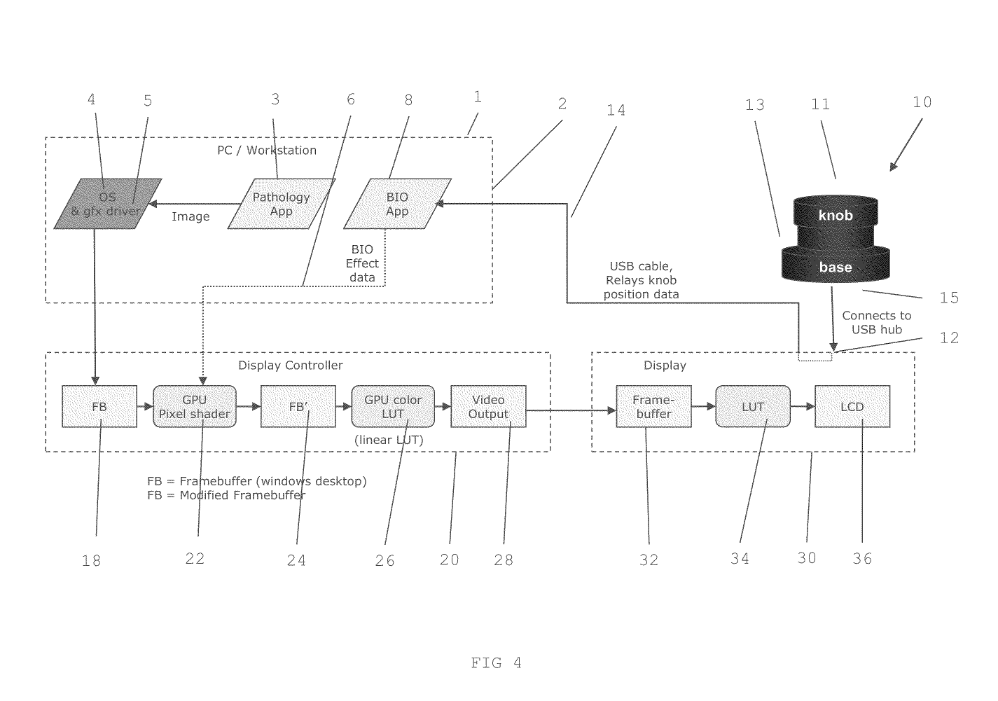

Referring to FIG. 4 modern display controllers 20 such as medical display controllers, provide a programmable pipeline. A part of this programmable hardware pipeline includes an array of SIMD processors that are capable of executing short software programs in parallel. These programs are called “pixel shaders”, “fragment shaders”, or “kernels”, and take pixels as an input, and generate new pixels as an output. In particular FIGS. 2 and 4 illustrate an embodiment of the present invention.

FIG. 4 shows a processing device 1 such as a personal computer (PC), a workstation, a tablet, a laptop, a PDA, a smartphone etc., a display controller 20 and a display 30. The processing device has a processor such as a microprocessor or an FPGA and memory. The processing device 1 can be provided with an operating system 4 and a graphics driver 5. An application such as a pathology application 3 can run on the processing device 1 and can provide an image to the display controller 20 under the control of the operating system 4 and the driver 5 for display on the pixels 36 of a display device 30 such as a screen (e.g. a fixed format display such as an LCD, OLED, plasma etc.) or projector and screen. Images may be input into the processing device 1 from any suitable input device such as from computer peripheral devices such as optical disks (CDROM, DVD-ROM, solid state memories, magnetic tapes, etc.) or via network communications interfaces (RS232, ETHERNET etc.) or bus interfaces such as IEEE-488-GPIB, ISA and EISA. Images may also be generated in processing device 1.

The image is stored in a frame buffer 18 in the display controller 20. A pixel shader 22 of display controller 20 processes the image and provides the new image to a further frame buffer 24. The new image is then provided with colour information from a colour Look-up-Table 26 and provided as a video output 28. The video output is stored in a frame buffer 32 of the display, optionally the image data further can be modified if necessary from a Look-up-Table 34 in the display before being supplied to the pixels 36 of the display 30.

In the second embodiment as shown schematically in FIG. 4 in combination with FIG. 2, the user input device 10 can be provided as a peripheral device 11, 13, 15 as shown and described with reference to FIG. 2. The peripheral device 11, 13, 15 is connected to the graphics processing device 1 such as a personal computer (PC), a workstation, a tablet, a laptop, a PDA, a smartphone etc. via one or more communication or computer peripheral interfaces 2, 12 and via a connection 14. As indicated above, the user input device may also be part of the display 30, e.g. when display 30 has a touch screen.

The one or more interfaces 2, 12 can be plug-and-play interfaces. At least one of the interfaces 12 can be a USB interface in a USB hub in the display 30 as an example but other wired or wireless communication interfaces, e.g. electronic, magnetic or optical interfaces could be used such as FireWire, WiFi, Bluetooth, Li-Fi. Especially Near Field Communication interfaces can be used for connecting the device 10. The connection 14 can be by cable or by a wireless connection, e.g. radio frequency or optical or magnetic. However, the present invention includes that the processing device 1 is located remotely on a data network such as a Local Area Network or the Internet hence the connection 14 can be via such a data network.

The processing device 1 is adapted to process or alter control signals for the display 30 based on user action that manipulates the user input device 10, e.g. peripheral device 11, 13, 15, e.g. by rotation as described with respect to FIG. 2. For example, a software application 8, which can run on the graphics processing device 1, responds to inputs from the user input device 10, e.g. peripheral device 11, 13, 15 and sends data and/or commands via channel 6 to the pixel shader 22 in the GPU via a customized display controller driver. The transfer of the control signals can take place by means of the channel 6 which can be a wired or wireless communication channel or a combination of both. Channel 6 is usually contained within the processing device 1. However, the transfer of the control signals can take place by means of plug and play interface, or a USB, Bluetooth, Firewire or Ethernet protocol. The present invention includes that the processing device 1 is located remotely on a data network such as a Local Area Network or the Internet hence the connection 6 can be via such a data network

A number of different programs for the processing functions are generated in the memory of the processing device 1 to create a library, e.g. by use of a compiler or other means. These programs are distributed to the processor of the processing device 1 to emulate the desired processing functions for the display. Preferably, the compiler generated programs are stored in memory to allow these to instantly execute desired processing functions to achieve real-time effects. This can be achieved by generating a real time electric signal which can be used to operate, or trigger, other items of hardware such as the display. In this embodiment the microscope emulation is executed in the GPU pixel shader 22 under the control of the user input device 10.

This transfer of data and/or commands over channel 6 allows the pixel shader 22 to apply an alteration in a relevant parameter of a processing function onto pixel data received from the frame buffer (18) before this data is sent to the display 30 via a video output 28. The modified frame buffer pixel data can be stored in intermediate “ping/pong” buffers such as 24, which are flipped synchronously to the display refresh. This double-buffering ensures no tearing is visible on the display 30. An advantage of this embodiment is that the GPU's colour (i.e. “gamma”) LUT 26 can be left in its neutral or linear state. Another advantage of the present embodiment is the flexibility of colour processing possible in the GPU pixel shader 22.

A variation of the first embodiment requires a driver which implements the tear-free double-buffered flipping mechanism.

Because of the execution on the GPU pixel shader 22, a small performance penalty for some applications might occur.

The or a software program running on the processing device 1 can be used for controlling the user input device 10.

In this embodiment alteration of the gamma parameter has been described. It is included within the scope of the present invention that applying this gamma correction can be done on luminance values (greyscale pixel data) or colour values such (R, G, B) triplets or triplets in other colour spaces such as but not limited to sRGB, adobe RGB, XYZ, YUV, HSV and others. Applying this gamma correction can also be done simultaneously on all members of a triplet (e.g. on R, G, and B values at the same time) or it could be done on one or more individual members only (e.g. only on the V component of the YUV colour space). Also, In case of applying the gamma value to non R,G,B triplets it may be necessary to perform a colour transformation from R,G,B to another colour space (e.g. YUV) and then back to R,G,B. In this example the gamma correction could be applied in YUV colour space. Also the gamma correction can be applied in colour space with more than three dimensions (e.g. CMYK space).

Although in this embodiment the alteration of the gamma parameter has been described by use of the user input device 10, the parameter(s) can equally well be backlight brightness, display brightness, display contrast, display colour point, colour settings, image processing filter settings, or calibration lookup table, or one to change a function that mimics brightness of the microscope light source, changing the light source spectrum of the microscope light source, adding optical filters to the microscope optical path, changing the zoom factor of the optical microscope, changing the position of the slide in the optical microscope.

Although in this embodiment the alteration of one parameter of the processing function has been described by use of the user input device 10, the present invention includes that two or more parameters of the processing functions are altered synchronously. For example, display brightness and gamma value can be altered synchronously, or display brightness and display colour settings are altered synchronously, or display brightness and display calibration lookup table are altered synchronously. The term “synchronously” preferably means within the same display frame or within the display frame blanking period.

### Embodiment 3

### Emulation Executed in GPU Color LUT

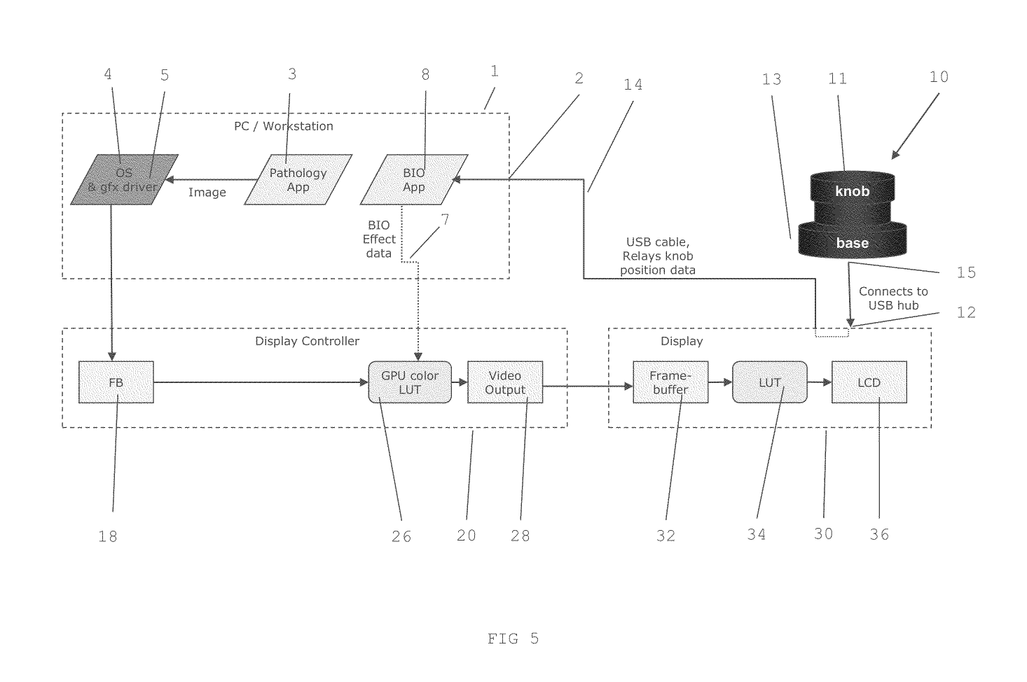

FIGS. 2 and 5 illustrate a third embodiment of the present invention. FIG. 5 shows a processing device 1 such as a personal computer (PC), a workstation, a laptop, a tablet, a smartphone etc., a display controller 20 and a display 30. The processing device 1 can have a processor such as a microprocessor or an FPGA, and memory. The processing device 1 can be provided with an operating system 4 and a graphics driver 5. An application such as a pathology application 3 may be running on the processing device 1 and provides an image to the display controller 20 under the control of the operating system 4 and the driver 5. Images may be input into the processing device 1 from any suitable input device such as from computer peripheral devices such a optical disks (CDROM, DVD-ROM, solid state memories, magnetic tapes, etc.) or via network communications interfaces (RS232, ETHERNET etc.) or bus interfaces such as IEEE-488-GPIB, ISA and EISA. The image data is stored in a frame buffer 18 of the display controller 20. The image data is then provided with colour information from a colour Look-up-Table 26 and subsequently provided as a video output 28. The video output is stored in a frame buffer 32 of the display, the image data further modified if necessary from a display Look-up-Table 34 before being supplied to the pixels 36 of the display 30.

In this embodiment, the user input device 10, e.g. peripheral device 11, 13, 15 as shown and described with respect to FIG. 2 is connected to the graphics processing device 1 such as a personal computer (PC), a workstation, a tablet, a laptop, a smartphone etc. via one or more communication or computer peripheral interfaces 2, 12 and by a connection 14 as described for the second embodiment. The input device 10 can however be integrated into the display, for example when the display is a touch screen.

The one or more interfaces 2, 12 can be plug-and-play interfaces. One of the interfaces 12 can be a USB interface in a USB hub in the display 30 as an example but other wired or wireless communication interfaces, e.g. electronic, magnetic or optical interfaces could be used such as FireWire, WiFi, Bluetooth, Li-Fi. Especially Near Field Communication interfaces can be used for connecting the device 10. The connection 14 can be by cable or by a wireless connection, e.g. radio frequency or optical or magnetic. However, the present invention includes that the processing device 1 is located remotely on a data network such as a Local Area Network or the Internet hence the connection 14 can be via such a data network.

The processing device 1 is adapted to process or alter control signals for the display 30 based on user action that manipulates the user input device 10, e.g. peripheral device 11, 13, 15, e.g. by rotation as described with respect to FIG. 2. In this embodiment altering the user input device 10, e.g. rotating the knob 11 will stretch the dark areas (e.g. clockwise rotation) or light areas (e.g. counter clockwise rotation) of the image—see FIG. 3. The perceived effect for the user is one of respectively higher brightness and lower brightness. This results in improved detail in respectively dark parts of the image and light parts of the image.

A software application 8 which can run on the graphics processing device 1 responds to inputs from the user input device 10, e.g. peripheral device 11, 13, 15 and programs the colour (gamma) LUT 26 in the display controller 20. This allows the colour LUT 26 to apply an alteration in the relevant parameter of the processing function onto pixel data received from the frame buffer (18) before this data is sent to the display. The transfer of the control signals such as data and/or commands from the processing device 1 can take place by means of the channel 7 which can be a wired or wireless communication channel or a combination of both. For example, the transfer of the control signals can take place by means of plug and play interface, or a USB, Bluetooth, Firewire or Ethernet protocol. Channel 7 will typically be included within the processing device 1. However, the present invention includes that the processing device 1 is located remotely on a data network such as a Local Area Network or the Internet hence the connection 7 can be via such a data network. In this embodiment the microscope emulation is executed in the GPU LUT 26 under the control of the user input device 10.

A number of different programs for the processing functions are generated in the memory to create the library, e.g. by a compiler or other means. These programs are distributed to the processor to emulate the desired processing functions. Preferably, the compiler generated programs are stored in memory to allow these to instantly execute desired processing functions to achieve real-time effects. This can be achieved by generating a real time electric signal which can be used to operate, or trigger, other items of hardware such as the display.

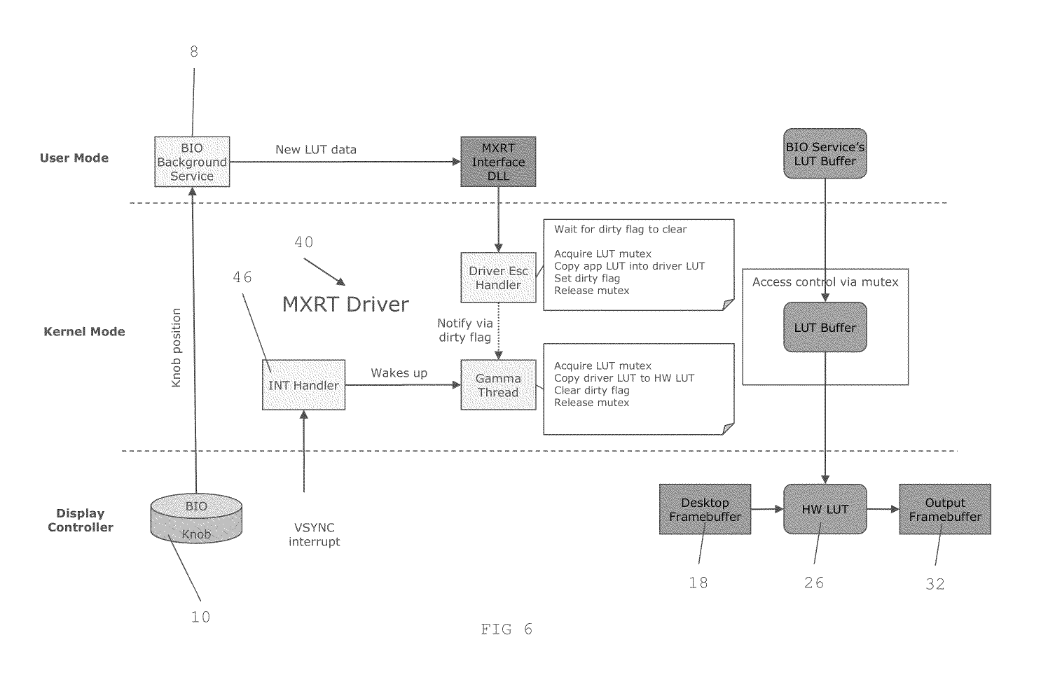

A customized display controller driver ensures these LUT updates applied to LUT 26 occur during the display's vertical blanking time as shown in FIG. 6. For example, updates to the GPU's HW/colour LUT 26 are performed by an MXRT driver 40 (the “MXRT” driver is a driver commercially available from BARCO NV of Kortrijk, Belgium) as it responds to the VSYNC interrupt, which occurs during the display blanking period. Synchronization of primitives in the driver 40 and tracking of a “dirty” flag allow the software application 8 to send asynchronous LUT updates to the MXRT driver 40. This embodiment preferably makes use of the driver 40 to ensure that colour LUT updates are synchronized to vertical refresh, to avoid visual artefacts when adjusting the user input device 10 such as the peripheral device 11, 13, 15. Alteration of the user input device 10, e.g. rotation of the knob 11 of the peripheral device 11, 13, 15 provides a new input to the application 8 running on the processing device 1. Modified data and/or commands are sent to the MXRT driver 40 from the application 8. As determined by the VSYNC interrupt and the interrupt handler 46, the driver 40 releases updated LUT values for transfer to the LUT 26. The LUT 26 modifies the image pixel data from frame buffer 18 and this modified pixel data is forwarded to the frame buffer 32 of the display 36 for display. For example, control of the update can be done by a flag that is set when the modified LUT information is received by the driver 40 and cleared on receipt of the VSYNC wake-up signal followed by transfer of the modified data to LUT 26.

The or a software program running on the processing device 1 can be used for controlling the user input device 10.

Although in this embodiment the alteration of the brightness has been described by means of the user input device 10, the parameter(s) can equally well be backlight brightness, display contrast, display colour point, colour settings, image processing filter settings, or calibration lookup table, or one to change a function that mimics brightness of the microscope light source, changing the light source spectrum of the microscope light source, adding optical filters to the microscope optical path, changing the zoom factor of the optical microscope, changing the position of the slide in the optical microscope.

Although in this embodiment the alteration of one parameter of the processing function has been described by means of the user input device 10, the present invention includes that two or more parameters of the processing functions are altered synchronously. For example, display brightness and gamma value can be altered synchronously, or display brightness and display colour settings are altered synchronously, or display brightness and display calibration lookup table are altered synchronously. The term “synchronously” preferably means within the same display frame or within the display frame blanking period.

### Embodiment 4

### Emulation Executed in the Display LUT

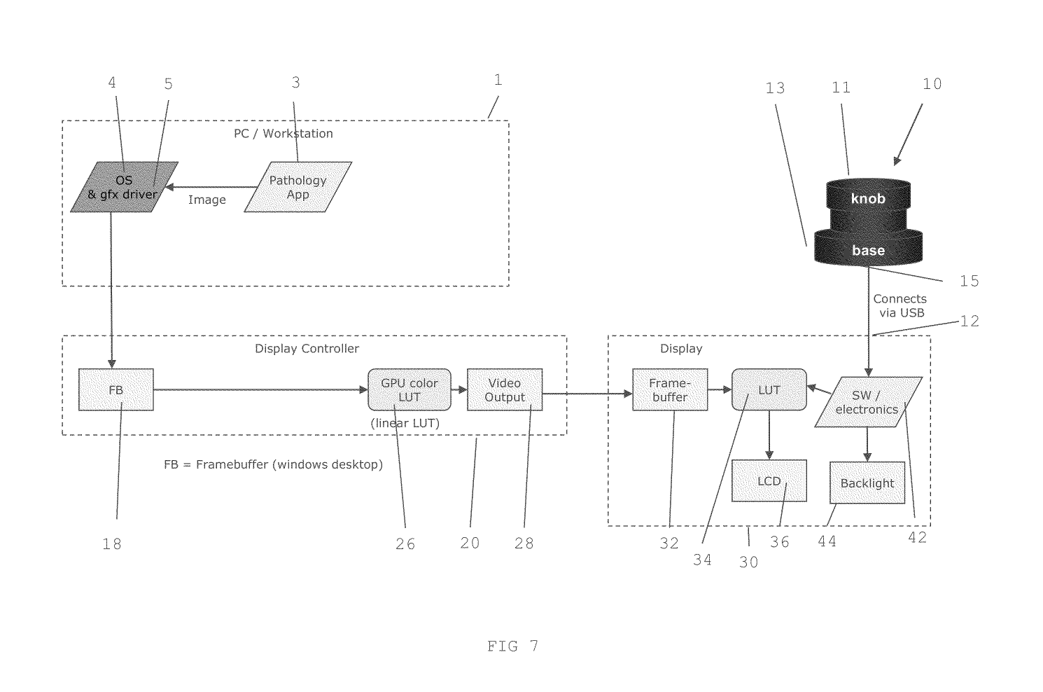

FIGS. 2 and 7 illustrate a further embodiment of the present invention. FIG. 7 shows a processing device 1 such as a personal computer (PC), a workstation, a laptop, a tablet, a smartphone etc., a display controller 20 and a display 30. The processing device 1 can be provided with a processor such as a microprocessor or an FPGA and memory. The processing device 1 can be provided with an operating system 4 and a graphics driver 5. Images may be input into the processing device 1 from any suitable input device such as from computer peripheral devices such a optical disks (CDROM, DVD-ROM, solid state memories, magnetic tapes, etc.) or via network communications interfaces (RS232, ETHERNET etc.) or bus interfaces such as IEEE-488-GPIB, ISA and EISA. An application such as a pathology application 3 may be running on the processing device 1 and provides an image to the display controller 20 under the control of the operating system 4 and the driver 5, e.g. in a conventional manner. The image data is transferred to and stored in a frame buffer 18 of the display controller 20. The image data is then provided with colour information from a colour Look-up-Table 26 and subsequently provided via a video output 28 to the display 30. The video output is stored in a frame buffer 32 of the display, the image data further modified (see below) from a Look-up-Table 34 before being supplied to the pixels 36 of the display 30. In this embodiment the microscope emulation is executed in the display 30 under the control of the user input device 10.

In this implementation, the user input device 10, e.g. peripheral device 11, 13, 15 is connected directly to the display 30 via an interface such as a plug and play interface of which a USB interface 12 is only one example, as well as a connection 14. However, the user input device 10 can be implemented in the display screen e.g. when this is a touch screen.

For example, the interface 12 can be a USB interface in a USB hub in the display 30 but other wired or wireless communication interfaces, e.g. electronic, magnetic or optical interfaces could be used such as FireWire, WiFi, Bluetooth, Li-Fi. Especially Near Field Communication interfaces can be used. Electronic circuitry 38 in the display 30 reads the user input device data, e.g. the knob position data and/or commands and programs the internal display LUT 34 to provide the alteration in the relevant parameter of the processing function. This embodiment requires the custom display electronics and/or firmware 38. The display 30 can include a processor such as a microprocessor or an FPGA, and memory. Communication interfaces can be used for connecting the device 10 to the display 30 and device 10 may include such an interface 15 as described with reference to FIG. 2. The connection 14 can be by cable or by a wireless connection, e.g. radio frequency or optical or magnetic.

A number of different programs for the processing functions are generated in the memory of the display 30 to create the library, e.g. by a compiler or other means. These programs are distributed to the processor of the display to emulate the desired processing functions. Preferably, the compiler generated programs are stored in memory to allow these to instantly execute desired processing functions to achieve real-time effects. This can be achieved by generating a real time electric signal which can be used to operate, or trigger, other items of hardware in the display 30.

In this embodiment altering the user input device 10, e.g. rotating the knob 11 changes a parameter of a processing function such as, for example, “stretching” the dark areas (e.g. clockwise rotation) or light areas (e.g. counter clockwise rotation) of the image—see FIG. 3. The perceived effect for the user is one of respectively higher brightness and lower brightness. This results in improved detail in respectively dark parts of the image and light parts of the image.

This embodiment has the advantage that it is completely independent of the display controller 20, the processing device 1 or the application 8 of the previous embodiments.

This embodiment is such that operation of the display 30 mimics that of a microscope. For example, in this embodiment the user input device 10, e.g. peripheral device 11, 13, is connected directly to the display 30 and is therefore able to control the backlight 44 of the display 30. To influence the backlight the brightness values or commands from the device 10 which are digital are converted into analog signals with a DAC 42, and the analog signals are used to drive the backlight 44. When altering the user input device 10, e.g. turning the knob 11 the backlight luminance will be changed in real-time such that the luminance of the display 30 changes. This is especially useful for LED backlights, where rapid control of the backlight is possible.

Note that a simple linear change of the display backlight DAC value is not preferred. The backlight of the display is usually highly non-linear. To achieve the same behaviour as on the optical microscope a backlight DAC lookup-table can be used such that when altering the user input device 10, e.g. turning the knob 11 of the peripheral device 11, 13, 15 the same change in luminance is achieved as on a typical optical microscope. In practice this Lookup Table can be configured by measuring the luminance output of an optical microscope when turning the control for light source intensity, and then creating a LookupTable such that when altering the user input device 10, e.g. turning the knob 11 the same percentual change in luminance will be achieved on the display. Note that this does not necessarily need to be a pure linear function. The goal is to match the change of luminance of the display with the change of luminance of the microscope by means of the DAC lookup table.

In this embodiment the SW electronics 38 of the display 30 are used to simultaneously change the backlight DAC value and the display LUT 34. Goal of simultaneously changing these two things is to achieve exactly the same perception as one would get with an optical microscope. This can be done by means of a model of the human eye (such as Barten's model, see Barten, P. G. J., “Contrast sensitivity of the human eye and its effects on image quality,” SPIE—The International Society for Optical Engineering, pp. 7-66, (1999), and Barten, P. G. J., “Spatio-temporal model for the Contrast Sensitivity of the human eye and its temporal Aspects” Proc. SPIE 1913-01 (1993)) that can calculate p-values (perceptual values) out of an image with known luminance values. For example the effect of changing the brightness of an optical microscope either by changing the light source or by adapting the diaphragm (which will also change the lighting of the slide) on the perceived image by calculation or measurement. Based on the same model of the human eye one can then calculate how the display LUT needs to be adapted such that when the display backlight is changed with the same amount of the optical microscope, also the image will be perceived similarly.

In this embodiment the SW electronics 38 of the display 30 can be used for controlling the user input device 10.

Although in this embodiment the alteration of the brightness has been described by use of the user input device 10, the parameter(s) can equally well be backlight brightness, display contrast, display colour point, colour settings, image processing filter settings, or calibration lookup table, or one to change a function that mimics brightness of the microscope light source, changing the light source spectrum of the microscope light source, adding optical filters to the microscope optical path, changing the zoom factor of the optical microscope, changing the position of the slide in the optical microscope.

Although in this embodiment the alteration of one parameter of the processing function has been described by use of the user input device 10, the present invention includes that two or more parameters of the processing functions are altered synchronously. For example, display brightness and gamma value can be altered synchronously, or display brightness and display colour settings are altered synchronously, or display brightness and display calibration lookup table are altered synchronously. The term “synchronously” preferably means within the same display frame or within the display frame blanking period.

### Summary of the Second to Fourth Embodiments

Common features of the three second to fourth embodiments are shown in table 1:

TABLE 1

| | 2nd | 3rd | |
|---|---|---|---|
| | embodiment | embodiment | |
| | GPU pixel | GPU color | 4^{th} |
| | shader (“Color | (“gamma”) | embodiment |
| | Processing”) | LUT | Display LUT |
| Knob connects to display | Yes | Yes | Yes |
| Need USB cable from | Yes | Yes | No |
| display to PC | | | |
| 30-bit from LUT to display | Yes* | Yes* | Yes |
| BIO effect is synchronized | Yes | Yes | Yes |
| to display refresh | | | |
| Supports any OS | No | No | Yes |
| Can use with any | Yes | Yes | Yes |
| application on supported | | | |
| OS | | | |
| Needs special graphics | Yes | Yes | No |
| driver | | | |
| Needs special display | No | No | Yes |

*30-bit to display requires particular video connection & format (such as DisplayPort DP30)

### Extensions/Improvements

The foregoing describes four embodiments of the present invention and modifications, obvious to those skilled in the art, can be made thereto without departing from the scope of the present invention. Some of these modifications are described below as further embodiments.

These embodiments can serve at least two purposes:
improving the accuracy/performance of the user input device 10, e.g. peripheral device 11, 13, 15 (e.g. more accurate mimicking of what happens in the microscope, adding extensions such as colour filters, introducing other luminance/colour functions that are better optimized for human readers, . . . )
reducing degradation of colour fidelity and avoiding unexpected behaviour that may create confusion with the users.

### Embodiment 5

### Color Filters

Pathologists using conventional microscopes currently place colour filters in the optical path to absorb or reflect particular wavelengths of light. A common use case is improving the contrast of histological stains. A further embodiment of the present invention starts from spectral data and applies filtering per wavelength, whereby with the current status of the image format of pathology images although spectral data per pixel is not available, an sRGB value is usually available. The alteration is achieved by means of the user input device 10.

In order to digitally mimic what is occurring optically, the transfer functions of the specimen, light source, filter, and human visual system need to be considered. The XYZ colour space allows us to best represent how colours are perceived in the human eye.

According to colour theory, by integrating the transfer functions by using the equations 1.0, 1.1 and 1.2, coefficients can be calculated which are multipliers in XYZ space that achieve the effect of an arbitrary optical filter. T_{f}(λ) is the transmission spectrum of the arbitrary colour filter. The resulting triplet (X_{f}, Y_{f}, Z_{f}) can be then multiplied with the colour pixel triplet (X, Y, Z) (equation 1.3). The resulting triplet (X′, Y′, Z′) is the final result. This operation is applied to each individual pixel.

$$\begin{matrix}{X}_{f} = \frac{{\sum }_{λ = 350 nm}^{λ = 780 nm} I ( λ ) \cdot {T}_{f} ( λ ) \cdot \overline{x} ( λ )}{{\sum }_{λ = 350 nm}^{λ = 780 nm} I ( λ ) \cdot \overline{x} ( λ )} & ( eq 1.0 ) \\ {Y}_{f} = \frac{{\sum }_{λ = 350 nm}^{λ = 780 nm} I ( λ ) \cdot {T}_{f} ( λ ) \cdot \overline{y} ( λ )}{{\sum }_{λ = 350 nm}^{λ = 780 nm} I ( λ ) \cdot \overline{y} ( λ )} & ( eq 1.1 ) \\ {Z}_{f} = \frac{{\sum }_{λ = 350 nm}^{λ = 780 nm} I ( λ ) \cdot {T}_{f} ( λ ) \cdot \overline{z} ( λ )}{{\sum }_{λ = 350 nm}^{λ = 780 nm} I ( λ ) \cdot \overline{z} ( λ )} & ( eq 1.2 ) \\ {X}^{′} = {X}_{f} \cdot X ; {Y}^{′} = {Y}_{f} \cdot Y ; {Z}^{′} = {Z}_{f} \cdot Z ; & ( eq 1.3 )\end{matrix}$$

A simple (3,3) colour space transformation matrix is used to transform XYZ pixel values into RGB values that allows application of the coefficients in RGB space as well (equation 1.4) and the other way around by applying the equation 1.5 and the inverse of the matrix M⁻¹. The Bradford matrices can be used for the conversion. These matrices allow the changing of the illuminant.

$$\begin{matrix}[ \begin{matrix}X \\ Y \\ Z\end{matrix} ] = [ M ] \cdot [ \begin{matrix}R \\ G \\ B\end{matrix} ] & ( eq 1.4 ) \\ [ \begin{matrix}R \\ G \\ B\end{matrix} ] = {[ M ]}^{- 1} \cdot [ \begin{matrix}X \\ Y \\ Z\end{matrix} ] & ( eq 1.5 )\end{matrix}$$

For instance having the sRGB color space with an illuminant D65, the matrix M has the coefficients given in equation 1.6 & 1.7.

| | | | | |
|---|---|---|---|---|
| [M] = | 0.4124564 | 0.3575761 | 0.1804375 | (eq 1.6) |
| | 0.2126729 | 0.7151522 | 0.0721750 | |
| | 0.0193339 | 0.1191920 | 0.9503041 | |
| [M]⁻¹ = | 3.2404542 | −1.5371385 | −0.4985314 | (eq 1.7) |
| | −0.9692660 | 1.8760108 | 0.0415560 | |
| | 0.0556434 | −0.2040259 | 1.0572252 | |

The effect of optical filters can be mimicked, in embodiments of the present invention, by applying these filter coefficients to the data path of the display system. This can be done using a user input device 10 e.g. by integrating this filter into the pixel processing data path, for example in the shader 22 of the display controller 20 (as described with reference to FIG. 4) or by configuring the LUT 34 in the display 30 (as described with reference to FIG. 7) or the LUT 26 of the display controller 20 (as described with respect to FIG. 5) such that this processing is integrated in the LUT 34, 26. In the latter cases, by applying these coefficients to a standard 2D RGB LUT (in the display to LUT 34) or in the display controller (to LUT 26), the effect of optical filters can be mimicked.

The transfer function for particular filters of relevance in pathology can be stored as presets that can be selected at the push of a button. These colour filter buttons may be keyboard shortcuts, on-screen icons or they may be buttons on a separate input device 10, e.g. buttons on the peripheral device 11, 13, 15. The peripheral device 11, 13, 15 has been described with reference to FIG. 2.

The user input device 10, e.g. peripheral device 11, 13, 15 can also be used to control the colour filtering, especially when considering applications of the concept outside of pathology. Firstly, embodiments of the present invention adjust the filter coefficients which can be seen as having the same effect as adjusting the white point of the illuminant. The user input device 10, e.g. peripheral device 11, 13, 15 can be used to control the “white point” of the image, assuming the image was originally in sRGB with white point of D65.

For example by altering the user input device 10, e.g. rotating knob 11 without pressing the button results in adjusting the white point from centre of gamut towards an edge (e.g. turn to right to increase filter effect, turn to left to return to original white point). On the other hand to rotate the knob 11 with the button pressed results in rotation of the white point vector (i.e. change chroma). Pressing the button resets to identity/the original white point. In this way, with a single knob and button combination one can smoothly move through the entire gamut of possible colour filters.

It is important to note that there are some limitations to what an optical filter is able to achieve, and embodiments of the present invention improve upon this in the digital domain. In particular, it is impossible to devise an optical filter that removes all colour wavelengths that humans perceive as yellow, without also affecting colours that humans perceive as red and green.

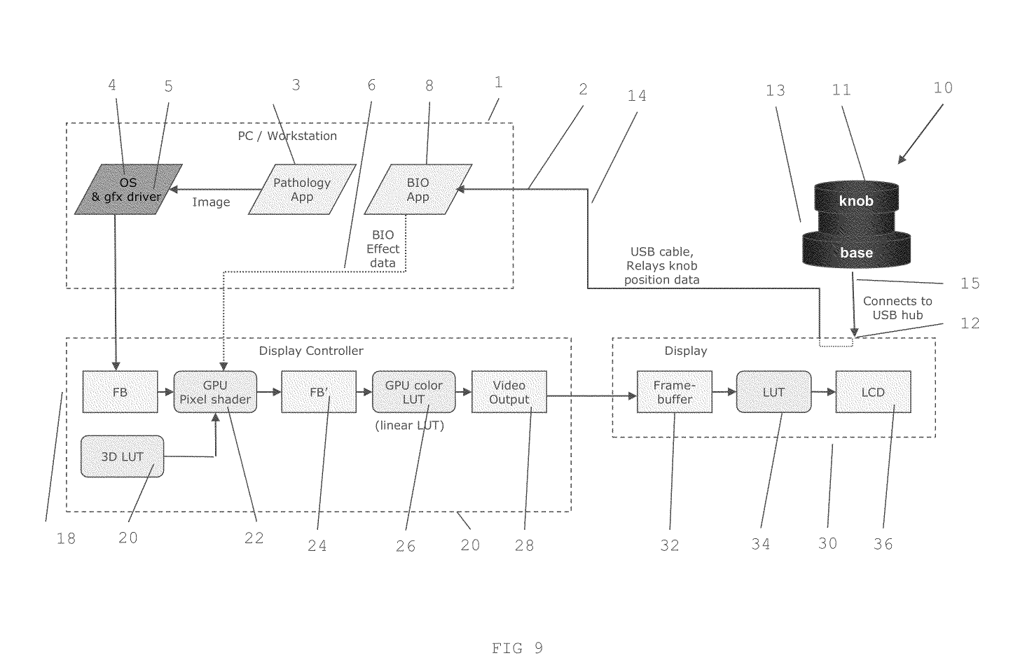

FIG. 8 represents this problem of traditional colour filtering methods. The source image of FIG. 8 is from http://www.olympusmicro.com/primer/lightandcolor/filter.html).

In the digital domain this can be solved by using the RGB components to do a lookup into a 3D LUT. Consider the problem of filtering out only what humans perceive as yellow. In a 3D LUT this is simple—just reduce or remove the region in the 3D LUT corresponding to yellow.

This embodiment has application in pathology, for example when particular stains result in certain colours which may or may not be of interest. With a 3D LUT, one could easily highlight colours of interest and reduce colours that are not interesting, which has the effect of improving the contrast of the stained slide.

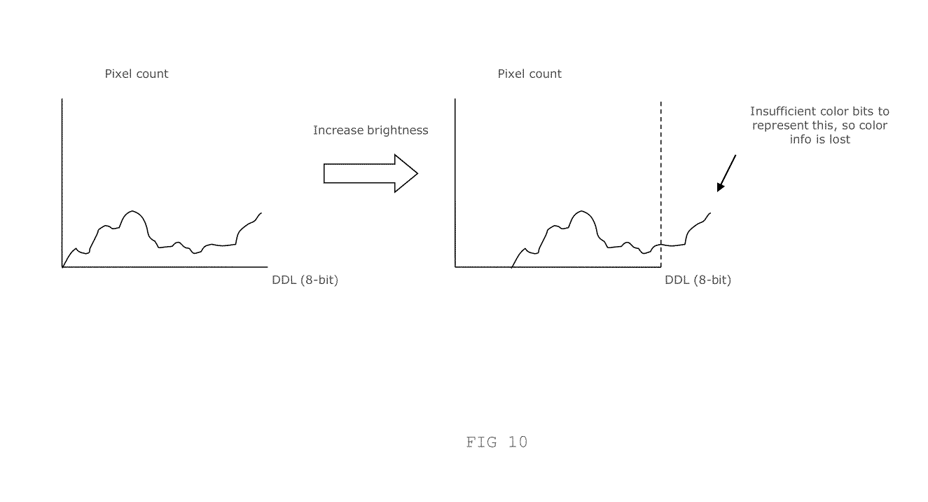

Such a 3D LUT can be implemented in a display (e.g. in or as LUT 34). In this case the display LUT 34 does no longer consist simply of three independent LUTs (one for each colour channel), but it is a true 3D LUT where a RGB output triplet is stored for each (or a subset of) RGB input triplet. Alternatively, this 3D LUT functionality can also be implemented as a post-processing texture-lookup in a GPU, e.g. provided in display controller 20—see FIG. 9. In FIG. 9 a 3D LUT 27 is added as input to the Pixel shader 22. Optionally for practical size/performance reasons downsampling the LUT 27 can be applied to reduce the number of entries so that the lookups can be done in real-time. In that case interpolation may be necessary to create an RGB output triplet corresponding to any arbitrary RGB input triplets for which no output value was stored in the 3D LUT 27.

FIG. 9 shows a processing device 1 such as a personal computer (PC), a workstation, a tablet, a laptop, a PDA, a smartphone etc., a display controller 20 and a display 30. The processing device has a processor such as a microprocessor or an FPGA and memory. The processing device 1 can be provided with an operating system 4 and a graphics driver 5. An application such as a pathology application 3 can run on the processing device 1 and can provide an image to the display controller 20 under the control of the operating system 4 and the driver 5 for display on the pixels 36 of a display device 30 such as a screen (e.g. a fixed format display such as an LCD, OLED, plasma etc.) or projector and screen. Images may be input into the processing device 1 from any suitable input device such as from computer peripheral devices such as optical disks (CDROM, DVD-ROM, solid state memories, magnetic tapes, etc.) or via network communications interfaces (RS232, ETHERNET etc.) or bus interfaces such as IEEE-488-GPIB, ISA and EISA. Images may also be generated in processing device 1.

The image is stored in a frame buffer 18 in the display controller 20. A pixel shader 22 of display controller 20 processes the image and provides the new image to a further frame buffer 24. The new image is then provided with colour information from a colour Look-up-Table 26 and provided as a video output 28. The video output is stored in a frame buffer 32 of the display, optionally the image data further can be modified if necessary from a Look-up-Table 34 in the display before being supplied to the pixels 36 of the display 30.

In this embodiment as shown schematically in FIG. 9 in combination with FIG. 2, the user input device 10, e.g. peripheral device 11, 13, 15 as shown and described with reference to FIG. 2 is connected to the graphics processing device 1 such as a personal computer (PC), a workstation, a tablet, a laptop, a PDA, a smartphone etc. via one or more communication or computer peripheral interfaces 2, 12 and via a connection 14. Alternatively, the user input device 10 can be integrated into the display screen, e.g. when this is a touch screen.

These one or more interfaces 2, 12 can be plug-and-play interfaces. At least one of the interfaces 12 can be a USB interface in a USB hub in the display 30 as an example but other wired or wireless communication interfaces, e.g. electronic, magnetic or optical interfaces could be used such as FireWire, WiFi, Bluetooth, Li-Fi. Especially Near Field Communication interfaces can be used for connecting the device 10. The connection 14 can be by cable or by a wireless connection, e.g. radio frequency or optical or magnetic.

However, the present invention includes that the processing device 1 is located remotely on a data network such as a Local Area Network or the Internet hence the connection 14 can be via such a data network.

A number of different programs for the processing functions are generated in the memory of the processing device 1 to create a library, e.g. by use of a compiler or other means. These programs are distributed to the processor of the processing device 1 and to the pixel shader 22 to emulate the desired processing functions for the display. Preferably, the compiler generated programs are stored in memory to allow these to instantly execute desired processing functions to achieve real-time effects. This can be achieved by generating a real time electric signal which can be used to operate, or trigger, other items of hardware such as the display.

A software application 8, which can run on the graphics processing device 1, responds to inputs from the user input device 10, e.g. peripheral device 11, 13, 15 and sends data and/or commands via channel 6 to the pixel shader 22 and the 3D LUT 27 in the GPU via a customized display controller driver. This transfer of data and/or commands over channel 6 allows the pixel shader 22 and the 3D LUT 27 to apply an alteration in a relevant parameter of a processing function onto pixel data received from the frame buffer (18) before this data is sent to the display 30 via a video output 28. The modified frame buffer pixel data can be stored in intermediate “ping/pong” buffers such as 24, which are flipped synchronously to the display refresh. This double-buffering ensures no tearing is visible on the display 30.

In this embodiment the microscope emulation is executed in the 3D LUT 27 and GPU pixel shader 22 under the control of the user input device 10.

Considering the GPU implementation in the display controller 20, this 3D LUT 27 operates a post-processing step that affects the entire display and can be implemented if there is access to the GPU driver. This can be achieved using a driver such as the MXRT driver 40 discussed above, in combination with a similar 3D LUT concept described above. For example, image updates from the 3D LUT 27 can be performed by an MXRT driver like driver 40 (see above), e.g. as it responds to the VSYNC interrupt (see FIG. 6), which occurs during the display blanking period. Synchronization of primitives in this driver and tracking of a “dirty” flag allows asynchronous 3D-LUT updates to be sent to the MXRT driver. This embodiment preferably makes use of the driver to ensure that colour LUT updates are synchronized to vertical refresh, to avoid visual artefacts when adjusting the peripheral device 10. Altering the user input device 10, e.g. rotation of the knob 11 provides a new input to the application 8 and modified data and/or commands are sent to the MXRT driver. As determined by the VSYNC interrupt and the interrupt handler, the driver releases updated 3D-LUT values for transfer to the pixel shader 22. The pixel shader 22 modifies the image pixel data from frame buffer 18 and this modified pixel data is forwarded to the frame buffer 32 of the display 30 for display. For example, control of the update can be done by a flag that is set when the modified LUT data is received by the driver and cleared on receipt of the VSYNC wake-up signal followed by transfer of the modified data to the pixel shader 22. No modification to the LUT 26 is required.

This embodiment may also provide:

Digital implementation of Rheinberg illumination, where lower intensity pixels are coloured differently than higher intensity pixels; and
Color transfer functions & gamut mapping.

Further embodiments of the present invention allow application of the user input device 10, e.g. peripheral device 11, 13, 15 with colour filters in case the spectrum of the slide (with stain) is (highly) peaked. In that case a simple tristimulus filtering (whether it is in R, G, B space; X, Y, Z space or any other space) will not work and it will even be confusing to the user to apply the filter.

Take for example a specific stain which has a rather peaked spectrum. When the microscope does not make use of a filter, the R/G/B values of tissue which is marked by the stain and other tissue which is not marked by the stain will not differ a lot. In the case of the optical microscope the pathologist then will apply a colour filter with a transmission spectrum which matches the emission spectrum of the stain/tissue/light source combination. That will result into a largely increased contrast of tissue that reacts to the stain, while other tissue will change less in colour or luminance.

Achieving this same effect by means of a digital image processing filter in a tristimulus space is inconvenient or impossible. The simple reason is that the tristimulus values of normal tissue and tissue that reacts to the stain will not differ a lot. Any regular digital filter that will be applied will therefore change the appearance of both normal and stain-reacted tissue in a very similar way, and the effect of the specific optical filter will not be reproduced. Even worse, the pathologist will have the impression that the digital filter works perfectly normally, because all the normal tissue will change colour as when imaged with the combination optical microscope and optical filter, BUT the appearance of tissue that reacts to the stain will not react similarly in the digital image processing case compared to the optical microscope+optical filter case.

In a further embodiment of the present invention images are scanned in multiple spectral bands (therefore creating some degree of spectral imaging) and a digital image processing filter is defined that will work well and mimic the behaviour of the optical filters used in optical microscopes. These digital filters will then take as input the spectral image and spectral transmission information of the optical filter that needs to be mimicked, and create as an output either processed spectral data or even data in a tristimulus space such as e.g. an sRGB, XYZ, RGB space. These digital image processing filters can e.g. be provided to the scanner manufacturers as an image processing library that they can call when they want to process or visualize the spectral image data from their scanners on to a visualization device such as a display.

A similar solution will also work to image wavelengths which are outside of the visual range, and for filters that have fluorescent behaviour.

### Embodiment 6

### Brightness Control to Better Mimic Optical Microscope Light Source Modulation

In this embodiment the user input device 10, e.g. peripheral device 11, 13, 15 is used to mimic what happens in an optical microscope when the pathologist changes the light source intensity. Adapting the gamma function of the display is not a good/optimal solution in this case.

### Mimicking Correct Luminance Behavior

This can be easily understood when looking at what physically happens when the light source of the microscope is changed in intensity. E.g. when the light source of the microscope is increased with 50% then image that will be presented to the eye/pathologist will be exactly the same except that the image will (in its entirety) be 50% brighter.

However, the user input device 10, e.g. peripheral device 11, 13, 15 in its first to third embodiments will not change the minimum and maximum brightness of the image. It will only change the transfer curve of the image that is being presented to the pathologist. In other words it will perform a kind of contrast enhancement for low, middle or high pixel values or any intermediate range. It is not possible to enhance all pixel values at the same time because the display does not run at higher luminance or higher contrast when changing the setting of the user input device 10, e.g. peripheral device 11, 13, 15.

This embodiment is such that the display better mimics the microscope. In this embodiment the user input device 10, e.g. peripheral device 11, 13, 15 is adapted to control the backlight of the display (similar to FIG. 7). When altering the user input device 10, e.g. turning the knob 11 of the peripheral device 11, 13, 15 the backlight luminance will be changed in real-time such that the luminance of the display changes. This is especially interesting for LED backlights, where one could have rapid control of the backlight.

Note that, just as for the fourth embodiment (FIG. 7), a simple linear change of the display backlight DAC value is not preferred. The backlight of the display is usually highly not linear. To achieve the same behaviour as on the optical microscope then a backlight DAC lookup-table can be created such that when altering the user input device 10, e.g. turning the knob 11 the same change in luminance is achieved as on a typical optical microscope. In practice this LookupTable can be configured by measuring e.g. the luminance output of an optical microscope when altering the user input device 10, e.g. turning the knob to control for light source intensity, and then creating a LookupTable such that when altering the user input device 10, e.g. turning the knob 11 of the peripheral device 11, 13, 15 the same percentual change in luminance will be achieved on the display. Note that this does not necessarily need to be a pure linear function. The goal is to match the change of luminance of the display with the change of luminance of the microscope by means of the DAC lookup table.

Refer to FIG. 7 the SW electronics of the display simultaneously changes the backlight DAC value and the display LUT. Goal of simultaneously changing these two things is as previously to achieve exactly the same perception as one would get with an optical microscope. By means of a model of the human eye (such as Barten's model) that can calculate p-values (perceptual values) out of an image with known luminance values. The effect of changing the brightness of an optical microscope can be calculated (note that sometimes the optical microscope will not change brightness of the light source but rather adapt the diaphragm, which will also change the lighting of the slide) on the perceived image. Based on the same model of the human eye one can then calculate how the display LUT needs to be adapted such that when the display backlight is changed with the same amount of the optical microscope, also the image will be perceived similarly.

In this embodiment the altering the user input device 10, e.g. peripheral 11, 13, 15 can be connected directly to the display 30 (as in FIG. 7), or if connected to the processing device 1 such as a workstation, one can use any suitable communications interface such as DDC, USB or Ethernet connection to send the backlight illumination instructions to the display. Alternatively the user input device 10 can be integrated in the display, e.g. when a touch screen is used. The display is adapted to ensure that the backlight adjustments are synchronized with the display refresh.

### Mimicking Light Source Colour Shift

A further improvement is not only matching the luminance behaviour of the optical microscope light source but also control the colour shift. Light sources typically shift spectrum when the luminance output is changed. Depending on the light source technology this could be significant or less. The old traditional light bulbs e.g. have a huge colour shift when modulating luminance, while new LEDs are more stable although there is still a shift present. An embodiment of the present invention also models and mimics this colour shift. This can be basically done in two ways.

In case there is a colour adjustable LED backlight, then a solution is to characterize the colour shift of the light source, and use this data to steer the (colour) DAC values of the display backlight such that not only the luminance output but also the colour output is correct. Depending on the desired accuracy, the colour DAC values of the backlight may or may not be sufficient to mimic the colour shift of the microscope light source, and as an additional refinement the LCD pixel data (R, G, B) values could be used to further make the result more accurate.

In case there is no colour adjustable backlight then the colour mimicking can be done purely by Lookup Tables that change the R, G, B values of the display. Note that change of these colour tables then will need to be synchronized with the change of Backlight DAC value in order not to have any visual artefacts.

### Display Compliance During Modulation

In some situations the display should maintain compliance with a certain standard such as DICOM GSDF, gamma XX, . . . when changing the display brightness. Just changing the backlight DAC will breach compliance of the display. An embodiment of the present invention changes the display LUTs synchronized with the change of backlight DAC values in such a way that independent of the DAC value/brightness setting the display remains compliant with the chosen standard while using the user input device 10, e.g. peripheral device 11, 13, 15.

### Embodiment 7

### Gamma as Best Option to Mimic Brightness in Pure Digital Image Processing Way

The diaphragm of an optical microscope controls the intensity of its backlight, which affects the brightness of the image seen.

If one attempts to reproduce this effect digitally through standard image processing methods of brightness adjustment, then one loses a significant amount of colour information at either the high or low end of the spectrum.

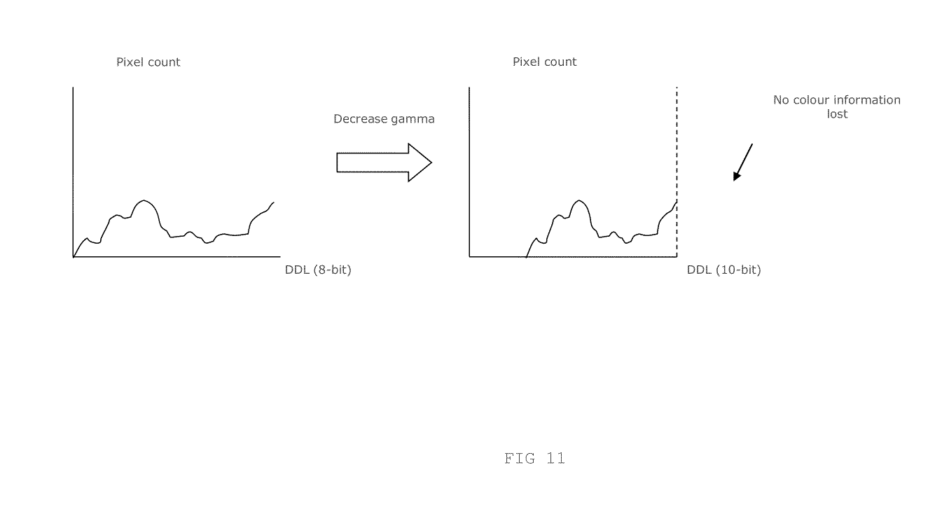

Consider histogram of an image shown in FIG. 10, and the histogram resulting from brightness adjustment. Pure image processing on the display can do nothing more than increasing the R, G, B values in order to increase the brightness of the presented image. But for saturated colours (e.g. R value=255) it just is not possible to increase the value even more. Therefore desaturation of colours will take place.

An embodiment of the present invention applies the same gamma function to each of the colour components in the image pixels, and the histogram is compressed so that colour information is not lost (assuming additional bits available in gamma LUT, e.g., 8-in, 10-out) while using the user input device 10, e.g. peripheral device 11, 13, 15. Moreover, a similar shifting effect of the histogram is achieved on one end of the spectrum. This solution works best if the gamma function is applied together with an increase in bit depth. In other words: it works best if the output bit depth of the gamma correction is higher (e.g. 10 bit) than the input bit depth (e.g. 8 bit). Consider the example of FIG. 11.

### Embodiment 8

### Alternative to a Simple Gamma Function which Will Provide Perceptual Similarity and/or Linearity in the Display

A simple gamma function clearly is not the best possible rendering option. As has been explained before, a simple gamma function can even result in undesired side effects. Embodiments of the present invention provide a better visualization function, depending on the exact goal.

### Perceptual Similarity

A first option is to aim at perceptual similarity. This means that the intention is to make the display resemble the optical microscope as well as possible. Note that this does not mean that the display needs to reproduce exactly the same luminance and/or colour values. The goal is that the image being viewed looks similar even though the absolute luminance and/or colour values may be different. Several metrics exist (e.g. JNDMetrix, SSIM, . . . ) that can calculate how similar two images will be perceived by an observer. In embodiments of the present invention these types of metrics can be used to compute and apply a mapping function that will ensure that the images rendered by the display look very similar to microscope images while using the user input device 10, e.g. peripheral device 11, 13, 15.

### Perceptual Linearity

Calibrating a display to the DICOM standard provides perceptual linearity in grayscale, and to a rough extent improves this for colour as well. Ensuring perceptual linearity in the display is important for achieving the desired effect of the user input device 10, e.g. peripheral device control. The reason is that, similar to radiology, it should be sure that subtle colour tints can be perceived by the pathologist, and that the visible contrast of these subtle colour differences is stable within one display and in between displays.

An additional consideration is that proper colour calibration and perceptual linearity within arbitrary colours is also important. Because the response of the display is not identical for red, green, and blue, it is typical to see a shift in chroma as the intensity of a colour is increased or decreased. Through colour calibration it is possible to prevent this chroma shift from occurring while using the user input device 10, e.g. peripheral device 11, 13, 15.

### Embodiment 9

As described above the emulator according to embodiments of the present invention comprises one or more digital processing engines in the form of a microprocessor, an FPGA or similar. The present invention also includes software that can be used to implement and operate the emulator on a computer based system. An embodiment of the present invention includes a computer program product for use with an optical microscope digital image processing emulator, the emulator comprising a processor, a memory, a user input device and being for use with a display, wherein the computer program product comprises code segments adapted to receive control signals generated by the input device based on a user input and to transfer the control signals to the processor and to emulate an operation of an optical microscope via a library of processing functions stored in the memory, the code segments being adapted to cause the processor to alter one or more parameters of the processing functions based on the control signals, when the code segments are executed on the processing engine. The code segments can be adapted to transfer the control signals first to a computer system and then to the display system. The code segments can be adapted to process or alter the control signals. The code segments can be adapted so that transfer of the control signals takes place by means of a wired or wireless communication channel or a combination of both. For example, the code segments can be adapted to control the input device, e.g. code segments can be adapted to transfer control signals to the input device. The code segments can be adapted alter a state or behaviour of the input device based on the control signals sent by the display to the input device. The code segments can be adapted alter a state or behaviour of the input device in order to provide feedback to the user.

In this embodiment the parameters of the processing functions can include any of backlight brightness, display brightness, display contrast, display colour point, colour settings, image processing filter settings, gamma value or calibration lookup table. In this embodiment the parameters can be configured to mimic the behaviour of an optical microscope or the processing functions are adapted to mimic the behaviour of an optical microscope. The behaviour of an optical microscopes includes at least one of changing brightness of the microscope light source, changing the light source spectrum of the microscope light source, adding optical filters to the microscope optical path, changing the zoom factor of the optical microscope, changing the position of the slide in the optical microscope.

The code segments can be adapted so that two or more parameters of the processing functions are altered synchronously, e.g.

so that display brightness and gamma value are altered synchronously,
so that display brightness and display colour settings are altered synchronously, or
so that display brightness and display calibration lookup table are altered synchronously

Synchronously preferably means within the same display frame or within the display frame blanking period.

The software described above may be stored on a signal storage medium, e.g. an optical storage medium such as a CD-ROM or a DVD-ROM, a magnetic tape, a magnetic disk, a diskette, a solid state memory etc.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. An optical microscope digital image processing emulator for use with a display, comprising:
a processor,
a memory,
a user input device, wherein
the emulator is programmable via a library of processing functions stored in the memory to emulate an operation of an optical microscope
the input device being adapted to generate control signals based on a user input, and
to transfer the control signals to the processor, the processor being adapted to alter one or more parameters of the processing functions based on the control signals.

2. The emulator according to claim 1, further comprising a computer system including a processor wherein the control signals are first transferred to the computer system and then transferred to the display.

3. The emulator according to claim 1 wherein the processor is embedded in the display.

4. The emulator according to claim 1, the user input device further comprises means for rotating a knob clockwise or counter clockwise with which the user interacts with the input device.

5. The emulator according to claim 4, wherein the means for rotating a knob clockwise or counter clockwise is adapted so that user interacts with the input device by controlling the rotation speed of the knob or the number of degrees the knob is being rotated

6. The emulator according to claim 1, further comprising a button, wherein the user interacts with the input device by pushing the button.

7. The emulator according to claim 6, further adapted so that the user interacts with the input device by controlling the duration of pushing the button

8. The emulator according to claim 1, wherein the parameters of the processing functions include any of backlight brightness, display brightness, display contrast, display colour point, colour settings, image processing filter settings, gamma value or calibration lookup table.

9. The emulator according to claim 8, adapted so that two or more parameters of the processing functions are altered synchronously.

10. The emulator according to claim 9, adapted so that display brightness and gamma value are altered synchronously

11. The emulator according to claim 9, adapted so that display brightness and display colour settings are altered synchronously.

12. The emulator according to claim 9, adapted so that display brightness and display calibration lookup table are altered synchronously

13. The emulator according to claim 8 wherein synchronously means within the same display frame or within the display frame blanking period.

14. The emulator of claim 1, wherein the input device is integrated in the display.

15. A method of operating an optical microscope digital image processing emulator, the optical microscope digital image processing emulator having a processor, a memory, a user input device and being for use with a display, wherein the emulator is programmable via a library of processing functions stored in the memory to emulate an operation of an optical microscope, the method comprising:
generating control signals based on a user input, and
transferring the control signals to the processor, the processor being adapted to alter one or more parameters of the processing functions based on the control signals.

16. A computer program product for use with an optical microscope digital image processing emulator, the emulator comprising a processor, a memory, a user input device and being for use with a display, wherein the computer program product comprises code segments adapted to receive control signals generated by the input device based on a user input and to transfer the control signals to the processor and to emulate an operation of an optical microscope via a library of processing functions stored in the memory, the code segments being adapted to cause the processor to alter one or more parameters of the processing functions based on the control signals, when the code segments are executed on a processing engine.

17. The computer program product according to claim 16, wherein the parameters of the processing functions include any of backlight brightness, display brightness, display contrast, display colour point, colour settings, image processing filter settings, gamma value or calibration lookup table.

18. The computer program product according to claim 17, adapted so that two or more parameters of the processing functions are altered synchronously.

19. The computer program product according to claim 18, adapted so that display brightness and gamma value are altered synchronously

20. The computer program product according to claim 18, adapted so that display brightness and display colour settings are altered synchronously.

21. The computer program product according to claim 18, adapted so that display brightness and display calibration lookup table are altered synchronously

22. The computer program product according to claim 18 wherein synchronously means within the same display frame or within the display frame blanking period.
